(19) United States
(12) Patent Application Publication
(10) Pub. No.: US 2011/0097027 A1
(43) Pub. Date: Apr. 28, 2011

(54) OUTER RING FOR WHEEL BEARING

(76) Inventors: Jong Soon Im, Seoul (KR); Hee Jae Yoon, Gyeonggi-do (KR); Hyeon Soo Lim, Seoul (KR)

(21) Appl. No.: 12/605,904

(22) Filed: Oct. 26, 2009

(51) Int. Cl. F16C 33/58

(52) U.S. Cl. 384/513

(57) ABSTRACT

An outer ring for a wheel bearing is provided. The outer ring is designed to attain optimal structural strength and thus prolong a service life of the bearing by establishing theory foundation for dimensions of a supporting end formed on an outer side of an outer diameter surface of the outer ring and a ring groove in which the snap ring is installed which is formed on an inner side of the outer diameter surface and applying optimal dimensions within an allowable threshold range to the supporting end and the ring groove. In addition, the outer ring is also designed to improve space usability of the outer ring by attaining an installing space of a seal member installed on the bearing through an extending end formed on an outer front end surface of the outer ring and improve an assembling property of a snap ring by making a portion of the outer ring from a ring groove to an inner front end as a step surface whose diameter is less than an overall diameter of the outer ring.

### BACKGROUND OF THE INVENTION

(a) Field of the Invention

The present invention relates to an outer ring for a wheel bearing. More particularly, the present invention relates to an outer ring for a wheel bearing, which can attain optimal structural strength by applying dimensions within an allowable threshold range to a supporting end, extending end, ring groove, and step surface of the outer ring and thereby prolonging a theory service life of the bearing.

(b) Description of the Related Art

Generally, a wheel bearing is a device that is connected between a suspension system and driving system of a vehicle to support the load of the vehicle and effectively rotates wheels. The wheel bearing is assembled between a hub and a knuckle to form a wheel bearing assembly.

FIG. 1 is a perspective view of a typical wheel bearing assembly and FIGS. 2 and 3 are cross-sectional views taken along line A-A of FIG. 1, illustrating application of an outer ring for a wheel bearing according to a related art.

The following will describe a typical wheel bearing assembly to which an outer ring for a wheel bearing according to a related art with reference to FIGS. 1 to 3 to describe the drawbacks and variation process of structural characteristics of the outer ring of the related art.

As shown in FIG. 1, the typical wheel bearing assembly 1 includes a hub 10 that receives torque from a driving shaft 3 through a spindle 7 of a constant velocity joint 5 and transfers the torque to wheels (not shown), a knuckle 20 connected to a suspension (not shown) of a vehicle, and a wheel bearing 30 (see FIG. 2 and, hereinafter, refer to as “bearing”) installed between the hub 10 and the knuckle 20.

As shown in FIG. 2, an inner ring of the bearing 30 is fitted to a seating portion 11 formed on an outer diameter portion of the hub 10 and an outer ring of the bearing 30 is fitted to an inner diameter portion 21 formed on a front end of the knuckle 20. The bearing 30 has a plurality of rolling elements 35 interposed between the inner and outer rings 31 and 33 thereof and is supported to be rotatable relative to the outer ring 33 fixed in a rotational direction.

Therefore, in a state where the hub 10 is splined to the spindle 7, the hub 10 is coupled to the wheel (not shown) of the vehicle by a flange 9 formed on an outer diameter surface thereof to transfer the torque of the driving shaft 3 to the wheel of the vehicle.

Hereinafter, In FIGS. 1 and 3, the left side where the wheel (not shown) is installed will be referred to as “inner side,” and the right side where the constant velocity joint 5 is installed will be referred to as “outer side.”

The following will describe the typical wheel bearing assembly shown in FIG. 2 in more detail. The bearing 30 includes the outer ring 33 having a raceway 33a on an inner diameter surface thereof, at least one inner ring having a raceway 31a on an outer diameter surface thereof, the rolling elements 35 interposed and rolling between the raceways 33a and 31a of the respective outer and inner rings 33 and 31, cages 37 formed along grooves (not shown) in which the rolling elements 35 are inserted and spaced apart from each other in a circumferential direction.

A lubricant is filled in a space defined between the outer and inner rings 33 and 31 and seal members 39 are installed between first ends of the inner and outer rings 33 and 31 and between second ends of the inner and outer rings 33 and 31 to prevent foreign substances from coming into the space and to prevent the lubricant filled in the space from leaking to an external side.

In order for the outer ring 33 of the bearing 30 to be fitted to the knuckle 20, the knuckle 20 is provided with the inner diameter portion 21 formed on a front end thereof. The inner diameter portion 21 is provided at an outer front end thereof with a protruding portion 23 for preventing the outer ring 33 of the bearing 30 from being separated outward in an axial direction. The inner diameter portion 21 is further provided at an inside thereof with an groove portion 25 in which a snap ring 41 for preventing the outer ring 33 of the bearing from being separated inward in the axial direction is installed.

In addition, the hub 10 includes a hub body 10a. The seating portion 11 to which the inner ring 31 of the bearing 30 is fitted is formed on an outer diameter surface of the inner side of the hub body 10a. The flange 9 extends along the outer diameter surface in a diameter direction of the hub body 10a and is connected to the wheel by a hub bolt B. Here, the hub body 10a is provided at an outer end portion thereof with a cap installing end 13 on which a hub cap (not shown) is installed. The hub body 10a is further provided at the inner diameter surface thereof with a spline S1 to which the spindle 7 is splined.

The following will describe an assembling process of the typical wheel bearing assembly 1. First, the bearing 30 is pressed into the inner diameter portion 21 of the knuckle 20 in a direction from the inner side to the outer side until the bearing 30 can be disposed on the protruding portion 23 and the snap ring 41 is inserted into the groove portion 25 formed on the knuckle 20 to assemble the bearing 30 on the knuckle 20.

After assembling the bearing on the knuckle 20, the hub 10 is pressed toward the inner ring 31 of the bearing 30 from the outer side to the inner side until the inner ring 31 is completely fitted to the seating portion 11 of the hub 10.

At this point, the spline S1 formed on the inner diameter surface of the hub body 10a is engaged with the spline S1 formed on the outer diameter surface of the spindle 7.

In this state, a spindle nut 45 is screw-coupled to a screw portion of the spindle 7 exposed to the inside of the cap installing end 13 to connect the wheel bearing assembly 1 to the spindle 7. At this point, an outer end 5b of an joint housing 5a of the constant velocity joint 5 axially supports the inner ring 31 of the bearing 30, and in this connection state, an inner gap of the bearing 30 is adjusted by tightening torque of the spindle nut 45.

There are a variety of factors that determines the service life of the bearing 30. Among the factors, the inner gap of the bearing 30 is the most important factor determining the service life of the bearing 30. That is, it is very important to accurately adjust the inner gap when mounting the bearing 30.

Meanwhile, the typical wheel bearing assembly 1 shown in FIG. 3 is formed by orbital-forming the inner end portion of the hub 10 of the wheel bearing assembly 1 of FIG. 2 with respect to the inner ring 31 of the bearing 30. That is, the orbital-forming process where the inner end portion of the hub 10 extends and the front end of the extended inner end is bent outward in the diameter direction is used such that the bent front end 47 can support the inner end of the inner ring 31 in the axial direction and thus the inner gap of the bearing 30 can be pre-adjusted by an orbital forming apparatus that can be precisely controlled.

As described above, the typical wheel bearing assembly 1 is configured such that, since the inner bent front end 47 of the hub 10 that is orbital-formed has predetermined strength, the inner gap of the bearing 30 is not highly affected by coupling torque of the spindle nut 45.

However, in the typical wheel bearing assembly 1, due to the constitution of the protruding portion 23 formed on the outer-front end of the inner diameter portion 21 of the knuckle 20 and the structural characteristics of the outer ring 33 of the bearing 30, the bearing 30 is first assembled on the knuckle 20 and is then the hub 10 is assembled on the bearing 20. Therefore, there is still a drawback that the raceways 33a and 31a of the bearing 30 are damaged by the management of the fitting apparatus in the course of assembling of the hub 10 on the bearing 30. Furthermore, the orbital forming process must be preformed after the knuckle 20, hub 10, and bearing 30 are all assembled with each other. Therefore, it is inconvenient to perform the orbital forming process.

In addition, the outer ring 33 applied to the above-described typical bearing assembly 1 is affected by turning force Fc (i.e., a lateral direction load) that is generated when the vehicle is making a turn. The turning force Fc acts in the axial direction of the wheel bearing assembly 1 and is transferred from the hub 10 to the outer ring 33 through the rolling elements 35 of the bearing 30.

The turning force Fc transferred to the outer ring 33 is further transferred to the knuckle 20 through the snap ring 41 that is an inner supporting point of the outer ring 33.

At this point, since the outer ring 33 does not has an outer supporting point for the knuckle 20, the outer ring 33 is deformed based on a center of the snap ring 41 that is the inner supporting point at a section S where the load F by the turning force Fc is transferred.

The deformed section S of the outer ring 33 by the turning force Fc is relatively long ranging from a contact center between the outer rolling element 35 of the bearing 30 to the inner front end of the outer ring 33. That is, the deformation of the outer ring 33 becomes larger even under equal turning force Fc.

Therefore, creep may occur between the outer ring 33 and the knuckle 20. This may cause the abnormal noise.

In order to solve the above-described drawbacks, i.e., the assembling drawback of the typical wheel bearing assembly 1 and the drawback caused by the turning force Fc, as shown in FIGS. 4 and 5, a new wheel bearing assembly in which a structure characteristic of the outer ring 33 of the bearing 30 fitted to the inner diameter portion 21 of the knuckle 20 is improved has been proposed.

The new wheel bearing assembly is disclosed in Korean Patent Application No. 10-206-0052175 (Jun. 9, 2006) by an application of this application. The basic structures of the knuckle 2, hub 10, and bearing 30 of the new wheel bearing assembly are identical to those of the typical wheel bearing assembly 1 but the assembling structure between the knuckle 20, bearing 30, and outer ring 33 of the new wheel bearing assembly is improved compared with the typical wheel bearing assembly 1.

That is, in the new wheel bearing assembly, the bearing 30 has a supporting end 51 that protrudes in a diameter direction along an outer diameter surface 34 on an outer end portion of the outer ring 33 to support the outer ring 33 in the fitting direction against the outer front end of the knuckle 20 and a ring groove 53 in which the snap ring 41 is installed and which is formed along an outer diameter surface 34 on a side of an inner portion of the outer ring 33 to support the outer ring 33 in a direction opposite to the fitting direction against the inner front end of the knuckle 20. Instead, the protruding portion 23 and the groove portion 25 that are formed on the knuckle 20 of the typical wheel bearing assembly for the same performance are omitted in the new wheel bearing assembly.

The constitution of the new wheel bearing assembly 1 will be described in more detail in “DETAILED DESCRIPTION OF THE EMBODIMENTS.”

Meanwhile, according to the new wheel bearing assembly 1, when the inner ring 31 of the bearing 30 is supported by orbital-forming the inner front end of the hub 10, the orbital forming is performed in a state where the bearing 30 is first assembled on the hub 10, after which the assembly of the hub 10 and the bearing 30 can be assembled on the knuckle 20 in a direction from an outer side to an inner side.

As described above, as the bearing 30 is first assembled on the hub 10 before assembled on the knuckle 20, it becomes easy to manage the fitting apparatus and thus the problem that the raceways 33a and 31a of the bearing 30 are damaged by the fitting load when the bearing 30 is fitted to the hub 10 can be solved. In addition, since the orbital forming is performed before the bearing 30 is assembled on the knuckle 20, the workability can be improved.

Further, in the new wheel bearing assembly 1, although the turning force Fc generated when the vehicle is making a turn is transferred from the hub 10 to the outer ring 33 through the rolling elements 35 of the bearing 30 and acts as the load F, the load F is transferred to the knuckle 20 as the supporting end 51 formed on the outer end portion of the outer ring 33 becomes the supporting point for the outer front end of the knuckle 20.

Therefore, the deformed section of the outer ring 33 by the turning force Fc moves from the contact center between the outer rolling element 35 of the bearing 30 to the outer front end of the knuckle 20 and thus the deformed section S of the outer ring 33 is reduced. In addition, the deformation of the outer ring 33 by the turning force Fc is also reduced and thus the creep and the abnormal noise caused by the creep can be suppressed.

As described above, the new wheel bearing assembly is designed such that the supporting end 51 formed on an outer side of the outer ring 33 of the bearing 30 and the ring groove 53 in which the snap ring 41 is installed and which is formed inside the outer ring 33 are constituted to change the assembling process. Therefore, the raceway damage problem of the bearing 30 is solved and the workability for the orbital forming process is improved. Further, there is an effect that the deforming section of the outer ring 33 is shifted outward and thus the deformation of the outer ring 33 is reduced.

However, although the new wheel bearing assembly has the above effects, the outer ring 33 has poor theory foundation for a dimension thereof when designing the supporting end 51 and the ring groove 53, it is difficult for the outer ring 33 to have optimal structural strength. Therefore, there is a need to establish theory foundation for a dimension of the supporting end 51 and ring groove 53 of the outer ring 33 within an allowable threshold range.

In addition, according to the new wheel bearing assembly 1, since the protruding portion 23 that has been formed on the knuckle 20 of the typical wheel bearing assembly is omitted, a gap between the inner surface of the flange 9 formed on the hub 10 and the outer front end of the outer ring 33 of the bearing 30 is widened. However, since the installing space for the seal member installed on the bearing 30 is not effectively attained, the space usability of the outer ring 33 is low. Further, since the outer ring 33 is designed such that a diameter of a portion from the ring groove 53 to the inner end portion in a direction where the snap ring 41 is installed is identical to the overall diameter of the outer ring 33, the snap-ring 41 must be greatly deformed to be inserted into the ring groove 53.

The above information disclosed in this Background section is only for enhancement of understanding of the background of the invention and therefore it may contain information that does not form the prior art that is already known in this country to a person of ordinary skill in the art.

### SUMMARY OF THE INVENTION

Embodiments have been made in an effort to provide an outer ring for a wheel bearing having advantages of attaining optimal structural strength and thus prolonging a service life of the bearing by establishing theory foundation for dimensions of a supporting end formed on an outer side of an outer diameter surface of the outer ring and a ring groove in which the snap ring is installed which is formed on an inner side of the outer diameter surface and applying optimal dimensions within an allowable threshold range to the supporting end and the ring groove.

Embodiments also provide an outer ring for a wheel bearing having an advantage of improving space usability of the outer ring by attaining an installing space of a seal member installed on the bearing through an extending end formed on an outer front end surface of the outer ring and improving an assembling property of a snap ring by making a portion of the outer ring from a ring groove to an inner front end as a step surface whose diameter is less than an overall diameter of the outer ring.

One embodiment provides an outer ring for a wheel bearing, including a supporting end that is formed on an outer side of an outer diameter surface of the outer ring and supported by an outer end of a knuckle; and a ring groove that is formed on an inner side of the outer ring and supported by an inner end of the knuckle and in which a snap ring is fitted, wherein the supporting end is dimensioned having a thickness of 1 mm or more at which the supporting end has a stress distribution within yield strength of the outer ring and a height above a section where maximum stress is applied to the supporting end under a cornering load condition less than 3 G.

When the thickness of the supporting end is 3 mm or more, the supporting end is dimensioned having a height of 1.65 mm or more.

In addition, a connecting portion between the supporting end and the outer diameter surface of the outer ring may be formed in a curved surface. At this point, the curved surface may be formed at two or more portions between the supporting end and the outer diameter surface of the outer ring.

That is, when the thickness of the supporting end is 4 mm or more, the curved surfaces may be formed at both sides of a flat inclined surface having a predetermined length, including a first curved surface having a curvature radius of 0.5 mm or more with the supporting ends and a second curved surface having a curvature radius of 1.2 mm with the outer diameter surface.

Alternatively, when the thickness of the supporting end is 4 mm or more, the curved surface may be defined by the supporting end and the outer diameter surface of the outer ring, having a curvature radius of 1.2 mm or more.

When a minimum thickness of the snap ring is 0.5 mm, the ring groove may be dimensioned having a depth of 0.5 mm or more,

The ring groove may be formed with a curvature radius of 0.1 mm or more between an inner circumference thereof and both inner surfaces.

Meanwhile, the supporting end may be dimensioned having a thickness of 3 mm or more at which the supporting end has a stress distribution within yield strength of the outer ring and a height above a section where maximum stress is applied to the supporting end under a cornering load condition less than 3 G.

At this point, the supporting end may be dimensioned having a height of 2 mm or more.

The outer ring may further include an extending end extending outward from an outer side front end surface.

The extending end may be dimensioned having a thickness less than a thickness of an outer end portion of the outer ring.

In addition, the extending end may be dimensioned having a length in an axial direction of 0.5 mm or more.

A connecting portion between the extending end and the supporting end may be formed in a curved surface having a curvature radius of 0.1 mm or more.

In addition, the outer ring may further include a step surface formed from the ring groove and an inner end portion, the step surface having an outer diameter less than an overall outer diameter of the outer ring.

A step between the outer diameter surface of the outer ring and the step surface may be dimensioned having 0.1 mm that is a minimum grinding process margin or less.

### BRIEF DESCRIPTION OF THE DRAWINGS

FIG. 1 is a perspective view of a typical wheel bearing assembly

FIGS. 2 and 3 are cross-sectional views taken along line A-A of FIG. 1, illustrating application of an outer ring for a wheel bearing according to a related art.

FIG. 4 is a cross-sectional view taken along line A-A of FIG. 1, illustrating a wheel bearing assembly to which an outer ring for a wheel bearing according to a first exemplary embodiment of the present invention is applied.

FIGS. 5 and 6 are respectively perspective and partly enlarged sectional views of the outer ring of FIG. 4.

FIG. 7 illustrates test models for simulation analysis for the outer ring of the first exemplary embodiment under a static strength test condition.

FIG. 8 is a view illustrating a static strength test condition for the outer ring of the first exemplary embodiment.

FIG. 9 is a property table of materials of constituent elements for the simulation analysis under the static strength test conditions of the wheel bearing assembly of the first exemplary embodiment.

FIGS. 10 and 11 are respectively a stress distribution graph and a stress distribution table of each load condition according to a simulation analysis result under the static strength test condition of the outer ring of the first exemplary embodiment.

FIGS. 12 and 13 illustrate a stress distribution showing a maximum stress generating portion between a supporting end and an outer ring according to a simulation analysis result under the static strength test condition of the outer ring of the first exemplary embodiment and a maximum stress generating section.

FIG. 14 illustrates test samples for a simulation analysis under a static strength test condition of a connecting portion between a supporting end of the outer ring and the outer ring of the first exemplary embodiment.

FIG. 15 illustrates a stress distribution of the connecting portion between the supporting end and the outer ring according to the simulation analysis result under the static strength test condition of the outer ring of the first exemplary embodiment of the present invention.

FIG. 16 is a cross-sectional view taken along line A-A of FIG. 1, illustrating a wheel bearing assembly to which an outer ring for a wheel bearing according to a second exemplary embodiment of the present invention is applied.

FIGS. 17 and 18 are respectively perspective and partly enlarged sectional views of the outer ring of FIG. 16.

### DETAILED DESCRIPTION OF THE EMBODIMENTS

Exemplary embodiments of the present invention will hereinafter be described in detail with reference to the accompanying drawings.

In the following description of the exemplary embodiments, identical functions and elements to the related art will be assigned with same names and numerical numbers as those of the related art and the detailed description thereof will be omitted.

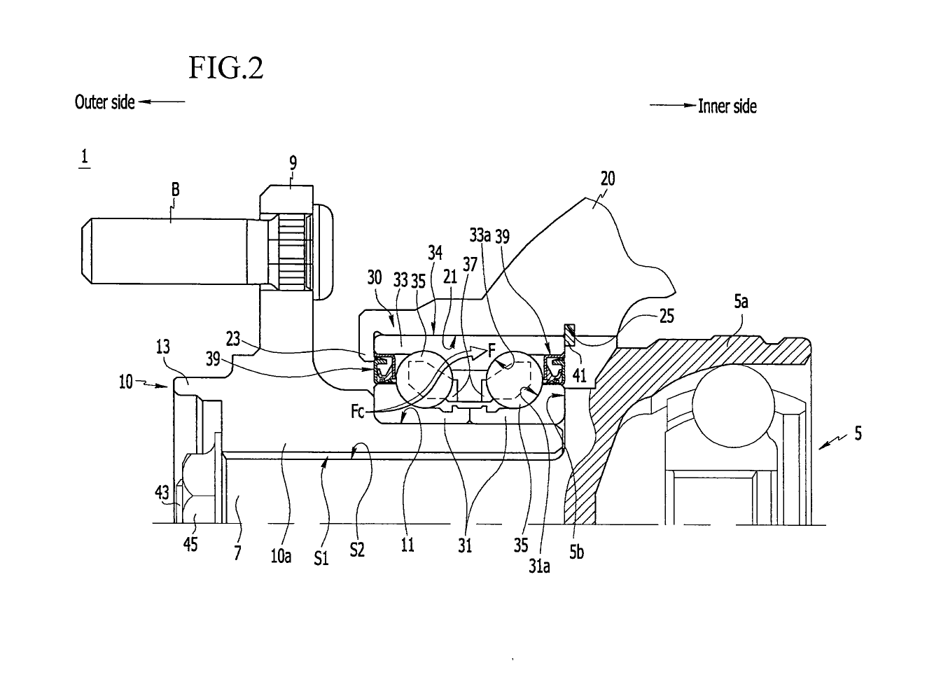

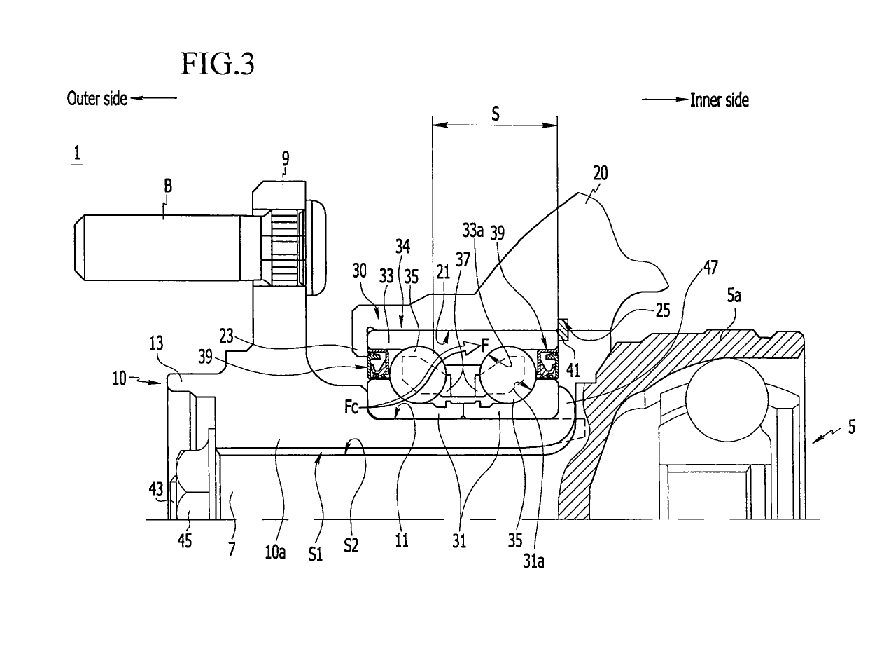

When describing an outer ring for a wheel bearing according to an exemplary embodiment of the present invention, as shown in FIGS. 2 and 3, a left side where a wheel is installed will be referred to as “outer side” and a right side where a constant velocity joint is installed will be referred to as “inner side.”

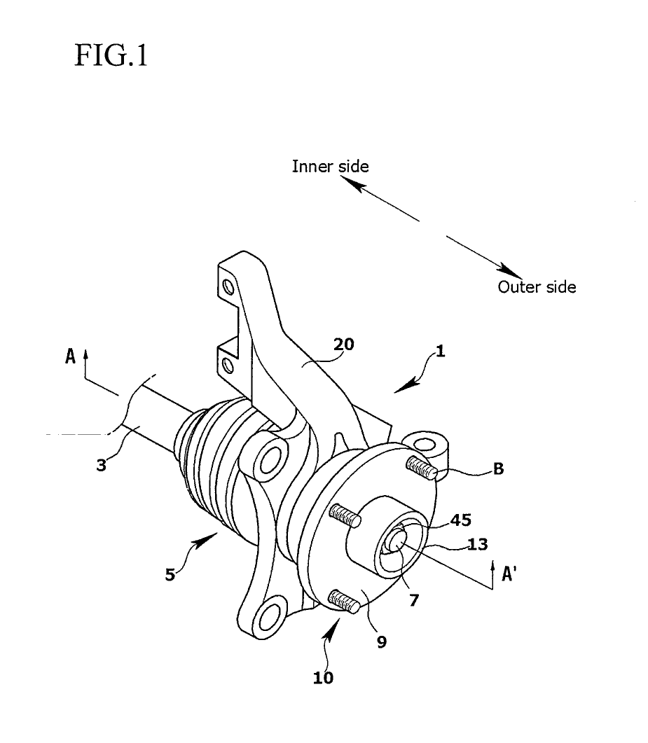

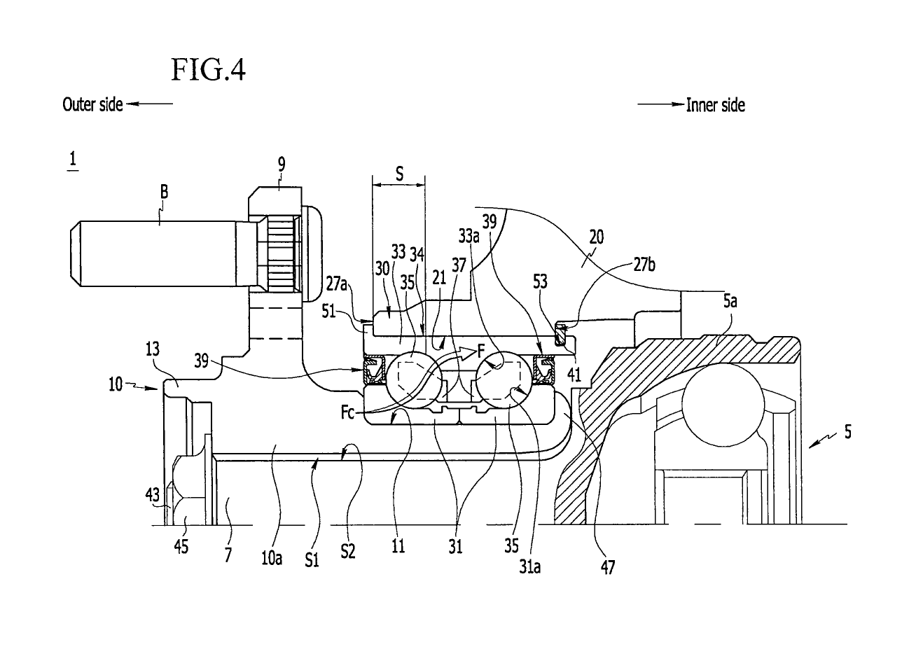

FIG. 4 is a cross-sectional view taken along line A-A of FIG. 1, illustrating a wheel bearing assembly to which an outer ring for a wheel bearing according to a first exemplary embodiment of the present invention is applied.

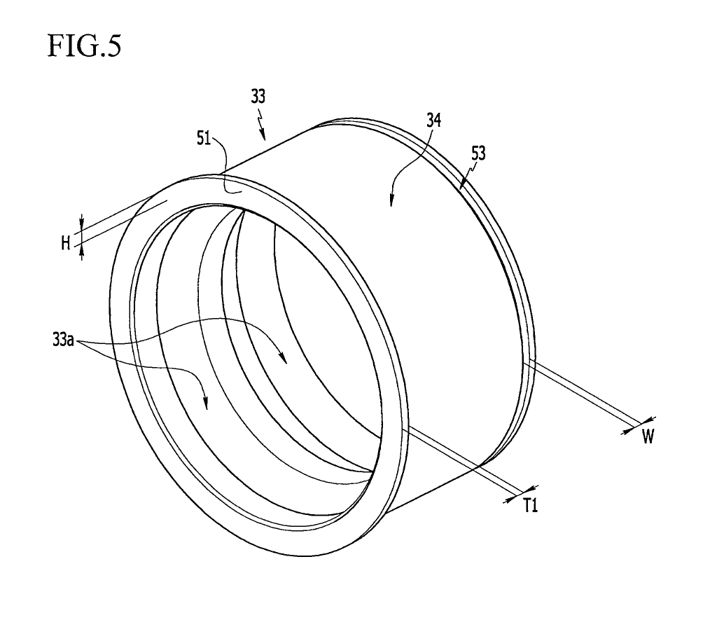

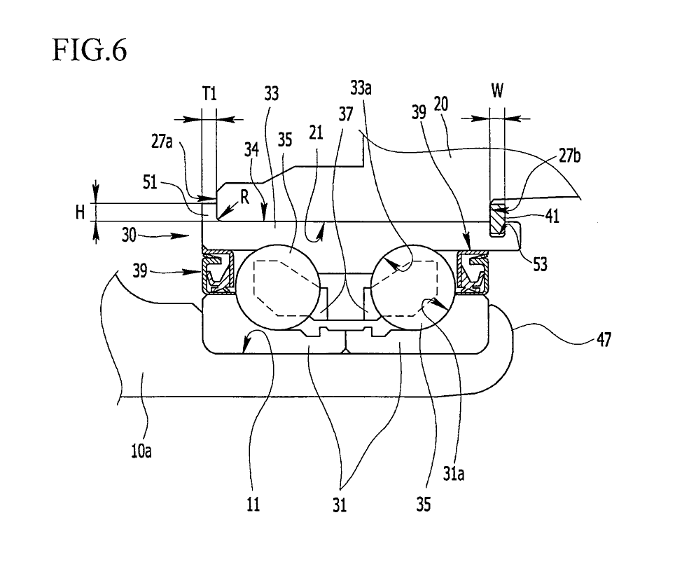

FIGS. 5 and 6 are respectively perspective and partly enlarged sectional views of the outer ring of FIG. 4.

In order to establish theory foundation for a dimension of an outer ring 33 and apply a dimension within an allowable threshold range to the outer ring 33, an overall constitution of a wheel bearing assembly 1 of a first exemplary embodiment, to which a supporting end 51 formed on an outer side of the outer ring 33 and a ring groove 53 in which a snap ring 41 is installed and which is formed on at an outer side of the outer ring 33 are applied will be described with reference to FIG. 4.

That is, as shown in FIG. 4, the wheel bearing assembly 1 to which the outer ring 33 of the first exemplary embodiment of the present invention is applied includes a hub 10 that receives torque from a driving shaft 3 through a spindle 7 of a constant velocity joint 5 and transfers the torque to wheels (not shown), a knuckle 20 connected to a suspension (not shown) of a vehicle, and a bearing 30 installed between the hub 10 and the knuckle 20.

The bearing 30 includes the outer ring 33 having a raceway 33a on an inner diameter surface thereof, an inner ring 31 having a raceway 31a on an outer diameter surface thereof, the rolling elements 35 interposed and rolling between the raceways 33a and 31a of the respective outer and inner rings 33 and 31, seal members 39 that are installed between first ends of the inner and outer rings 33 and 31 and between second ends of the inner and outer rings 33 and 31 to prevent foreign substances from coming into the space and to prevent a lubricant filled in a space between the outer and inner rings 33 and 31 from leaking to an external side, and cages 37 formed along grooves (not shown) in which the rolling elements 35 are inserted and spaced apart from each other in a circumferential direction.

In the wheel bearing assembly 1 for a vehicle, the rolling elements 35 are arranged along two lines (i.e., an outer line and an inner line).

The knuckle 20 is connected to a vehicle body by a suspension (not shown). The knuckle 20 is provided at a front end thereof with an inner diameter 21 within which the outer ring 33 is inserted. The knuckle 20 is further provided at outer and inner end portions with a flat outer and inner ends 27a and 27b.

The hub 10 includes a hub body 10a and a flange 9 for coupling to a vehicle wheel.

The inner ring 31 of the bearing 30 is inserted into an inner side of the outer diameter surface of the hub body 10a. The hub body 10a is provided at an outer end portion thereof with a circular cap installing end 13 along a circumference of the outer end portion so that a hub cap can be mounted on the hub body 10a. The hub body 10a is provided at an inner diameter surface thereof with a spline S1 coupled to a spline S2 of the spindle 7.

In addition, the flange 9 extends along the outer diameter surface of the hub body 10a in a diameter direction and is integrally formed with the hub body 10a so that it can be coupled to the vehicle wheel by a hub bolt B.

At this point, an orbital-forming process where the inner end portion of the hub 10 extends and the front end of the extended inner end is bent outward in the diameter direction is used such that the bent front end 47 can support the inner end of the inner ring 31 in the axial direction and thus the inner gap of the bearing 30 can be pre-adjusted by an orbital forming apparatus that can be precisely controlled.

In the wheel bearing assembly 1 having the above-described structure, as shown in FIGS. 5 and 6, a supporting end 51 is formed on the outer side of the outer diameter surface 34 of the outer ring 33 and a ring groove 53 in which the snap-ring 41 is inserted is formed on the inner side of the outer diameter surface 34 of the outer ring 33.

Describing an assembling process of the wheel bearing assembly 1 to which the above-described outer ring 33 for the wheel bearing is applied, the bearing 30 is fitted to the hub 10 by pressing the bearing 30 in a direction from the inner side to the outer side of the hub 10 such that the inner ring 31 of the bearing 30 is installed in the seating portion 11 of the hub 10.

After the inner ring 31 is installed on the seating portion 11 of the hub 10, the inner side front end of the hub 10 is orbital-formed to support the inner ring 31 of the bearing 30 in an axial direction.

After assembling the bearing 30 and the hub 10, the bearing 30 assembled with the hub 10 is fitted to the inner diameter portion 21 of the knuckle 20 by pressing the bearing 30 in a direction from the outer side to the inner side such that the supporting end 51 of the outer ring 33 is supported by an outer end 27a of the knuckle 20. In a state where the outer ring 33 is completely fitted to the inner diameter portion 21, the snap ring 41 is installed in the ring groove 53 of the outer ring 33 so that the outer ring 33 can be supported by the inner end of the knuckle 20.

At this point, as the spindle 7 of the constant velocity joint 5 is inserted through the inner diameter surface of the hub 10, the spline S2 of the spindle 7 is engaged with the spline S1 formed on the inner diameter surface of the hub 10. In this state, a spindle nut 45 is coupled to a screw portion 43 of the spindle 7 exposed to an inside of the cap installing end 13 of the hub 10, thereby connecting the wheel bearing assembly 1 to the spindle 7.

As described above, as can be noted from an overall structure and assembling process of the wheel bearing assembly 1 to which the outer ring 33 of the first exemplary embodiment is applied, the drawback that the raceways 33a and 31a of the bearing 30 are damaged as in the related art can be solved by changing the assembling order by applying the supporting end 51 and the ring groove 53 that are respectively formed on the outer and inner sides of the outer diameter surface 34 of the outer ring 33 and thus the workability for the orbital forming process can be improved. In addition, the deformed portion of the outer ring 33 by turning force Fc is shifted to the outer side, the deformation of the outer ring 33 can be reduced. However, in order to prolong a theory service life by attaining optimal structural strength determined by dimensions of the supporting end 51 and ring groove 53 on the outer ring 33, optimal dimensions of the supporting end 51 and ring groove 53 within an allowable threshold range must be established.

The optimal dimensions of the supporting end 51 and ring groove 53 within the allowable threshold range and the theory foundation on the optimal dimensions are as follows:

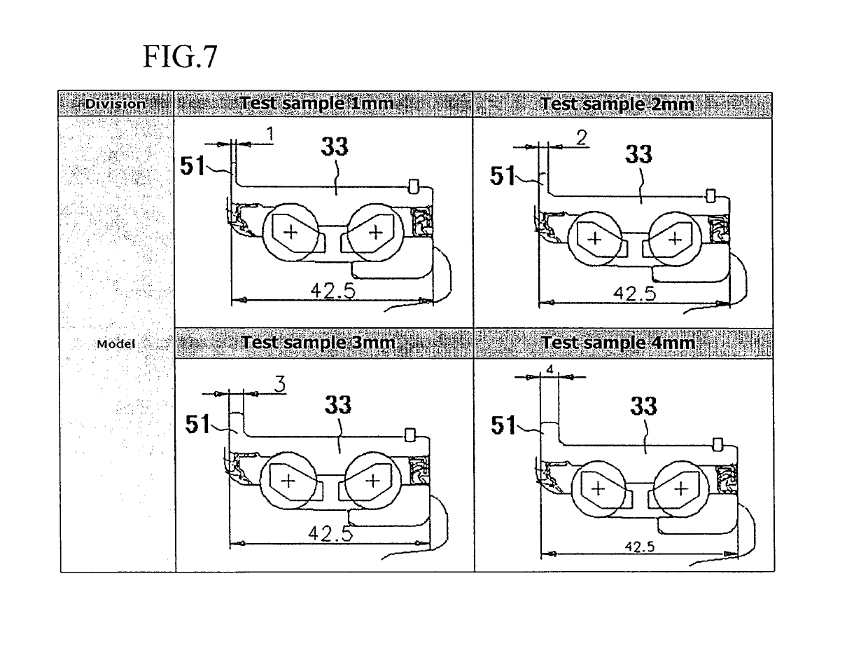

First, in order to establish an optimal dimension (an optimal thickness T and an optimal height H) of the supporting end 51 of the outer ring 33, as shown in FIG. 7, four test samples having thicknesses T1 of 1 mm, 2 mm, 3 mm, and 4 mm, respectively, for the supporting end 51 are first provided and stress distribution of each test sample are analyzed through a simulation analysis under a static strength test condition.

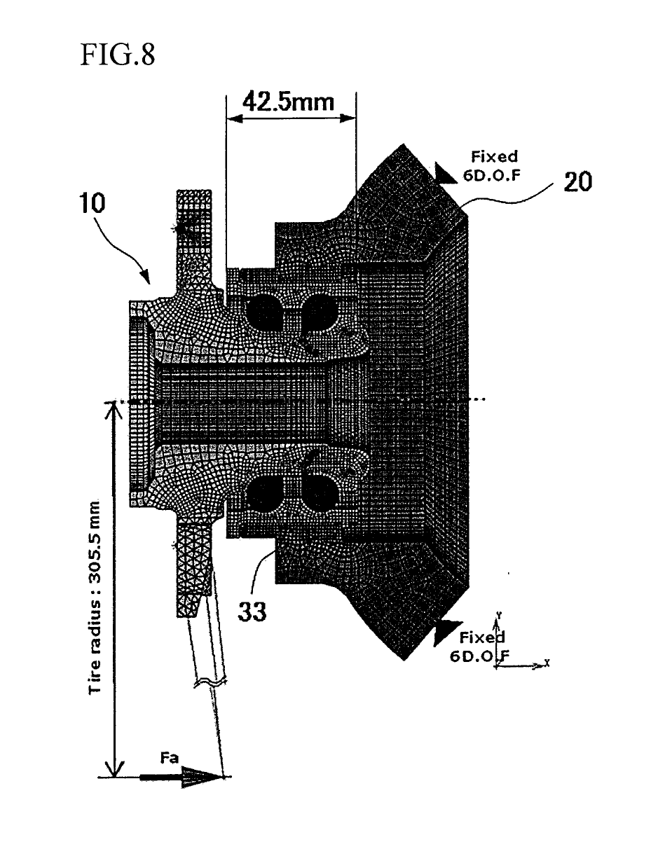

As shown in FIG. 8, a vehicle applied under the simulation condition has an axle-load GVW of 930 kgf and a tire radius of 305.5 mm. The outer ring 33 of the first exemplary embodiment has an outer diameter of 75-80 mm, an axial length of 42 mm. The knuckle is fixed with respect to 6-degree of freedom and, at this point, a load Fa applied is a gravity of 1-6 G under a cornering load condition.

Here, since “Axle-Load/2” is applied per tire pitch, the load Fa applied becomes “(930 kgf/2)×6” (i.e., 2,790 kgf) when the gravity of 6 G acts.

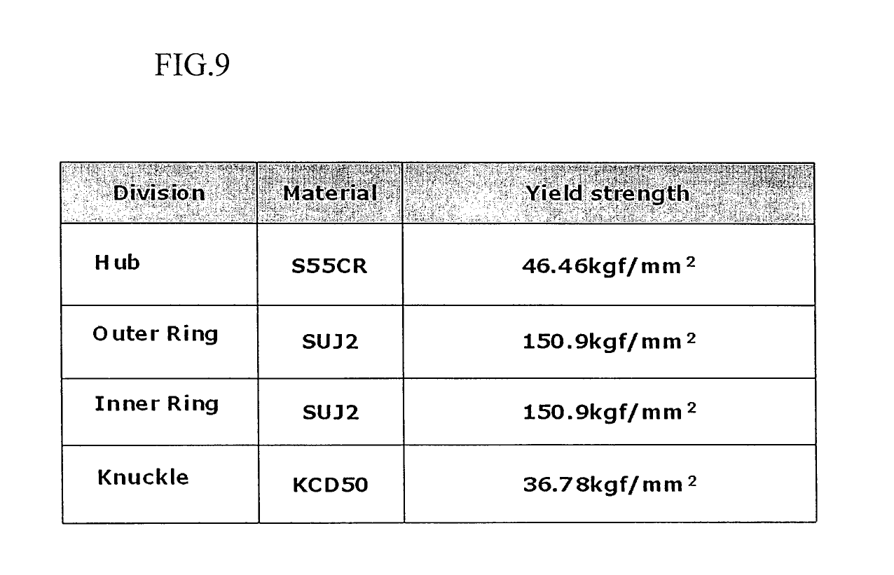

Meanwhile, describing the properties of materials of the respective constituent elements of the wheel bearing assembly 1 for the test samples, as shown in FIG. 9, the hub 10 is formed of a steel material such as S55CR and has yield strength of 46.46 kgf/mm². In addition, the inner and outer rings 31 and 33 are formed of a steel material such as SUJ2 and yield strength of the bearing is 150.9 kgf/mm². The knuckle 20 is formed of a steel material such as KCD50 and has yield strength of 36.78 kgf/mm².

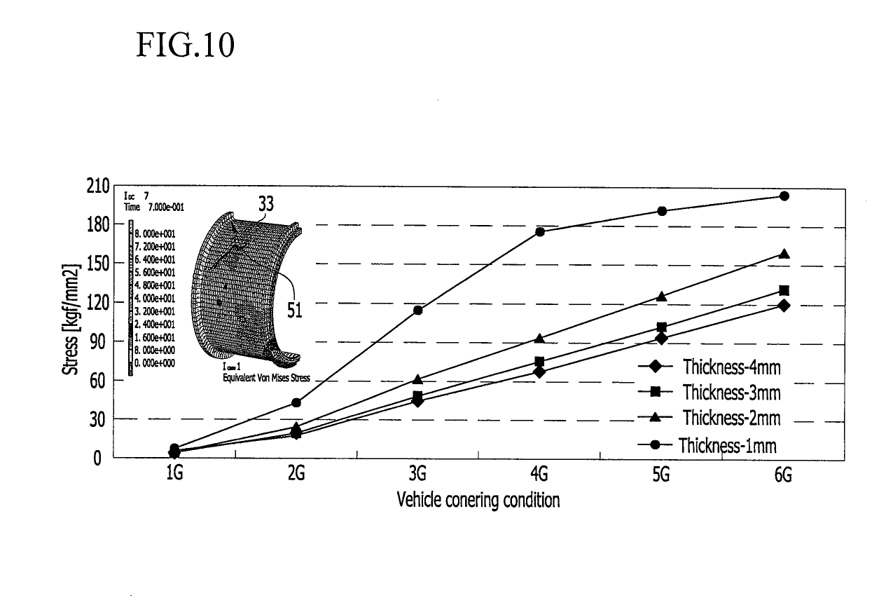

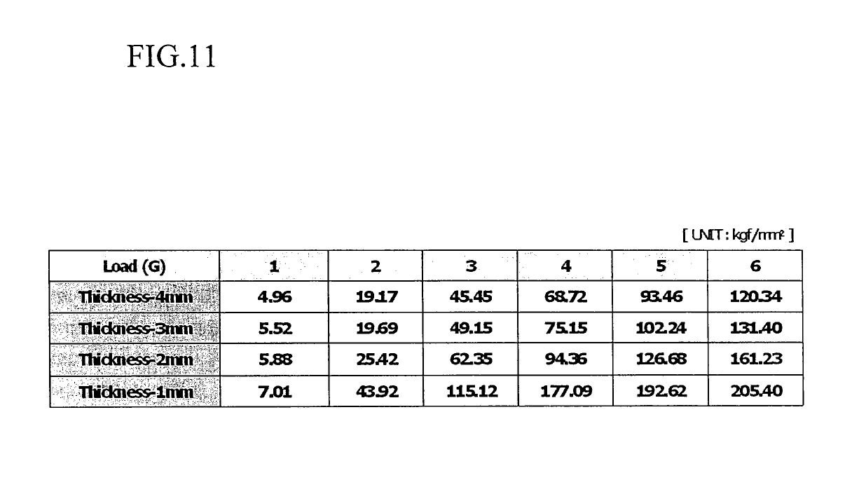

As shown in FIGS. 10 and 11, stress distributions of the supporting ends of the respective test samples having respectively thicknesses T1 of 1 mm, 2 mm, and 3 mm are less than 150.9 kgf/mm², which is yield strength of the outer ring 33, under all load conditions. In addition, under the load conditions less than 3 G, even the stress distribution of the supporting end of the test sample having the thickness T1 of 1 mm is less than 150.9 kgf/mm² that is yield strength of the outer ring 33.

Accordingly, the thickness T1 of the supporting end 51, which can be applied under all load conditions (less than 6 G), must be at least 3 mm. The thickness T1 of the supporting end 51, which can be applied under the load condition less than 3 G must be 1 mm or more.

The thickness T1 of the supporting end 51 may be established in proportion to a specification of the outer ring of the first exemplary embodiment.

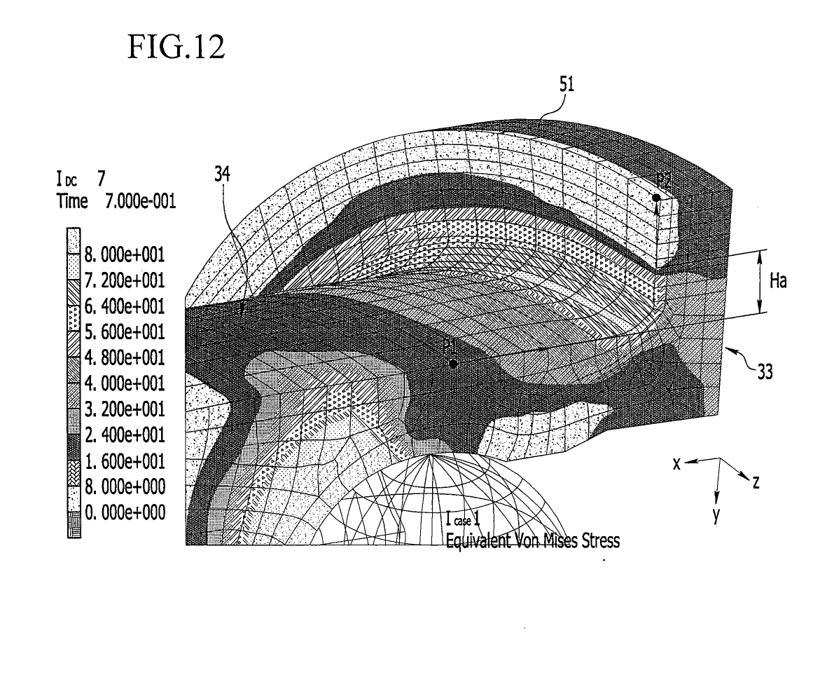

Meanwhile, as shown in FIG. 12, the optimal height H of the supporting end 51 formed on the outer ring 33 is established through the simulation analysis of a maximum stress of the stress generating portion of the test sample having the thickness T1 of 3 mm having a stress distribution less than the yield stress under all load conditions and the stress generation height.

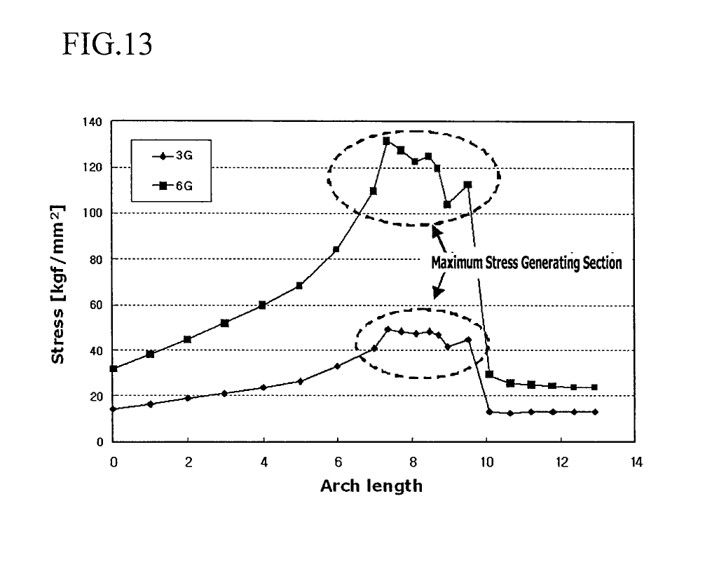

In the stress distribution between nodes P1 and P2 on the outer diameter surface 34 of the outer ring 33, as shown in a stress graph of FIG. 13, the maximum stress is generated on a connecting portion between the supporting end 51 and the outer diameter surface 34, which is close to an arch length of 8 mm, regardless of the load condition. At this point, when the load condition is 3 G, the height Ha of the supporting end 51, at which the maximum stress is generated, is 1.62 mm. When the load condition is 6 G, the height Ha of the supporting end 51, at which the maximum stress is generated, is 2 mm.

Accordingly, the height H of the supporting end 51, which can be applied under all load conditions, must be 1.65 mm or more when the thickness T1 is 3 mm, preferably, 5 mm or more to attain a minimum contacting sectional area with the knuckle 20.

The height H of the supporting end 51 may be established in proportion to the specification of the outer ring of the first exemplary embodiment.

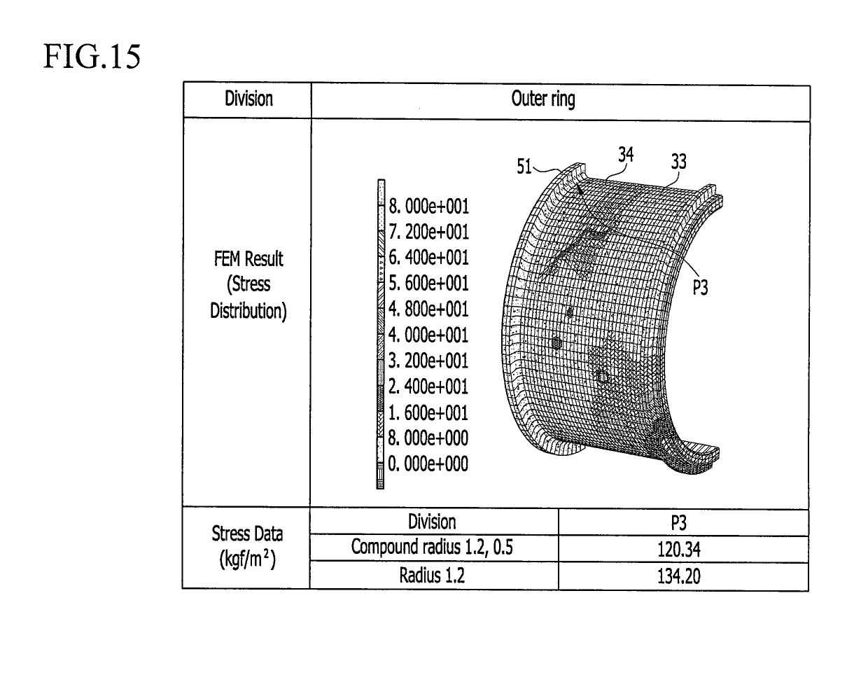

According to the first exemplary embodiment, the outer ring 33 is provided at the outer side of the outer diameter surface 34 with the supporting end 51 and thus, as shown in FIG. 15, the connecting portion P3 between the supporting end 51 and the outer diameter surface 34 is formed in a curved surface.

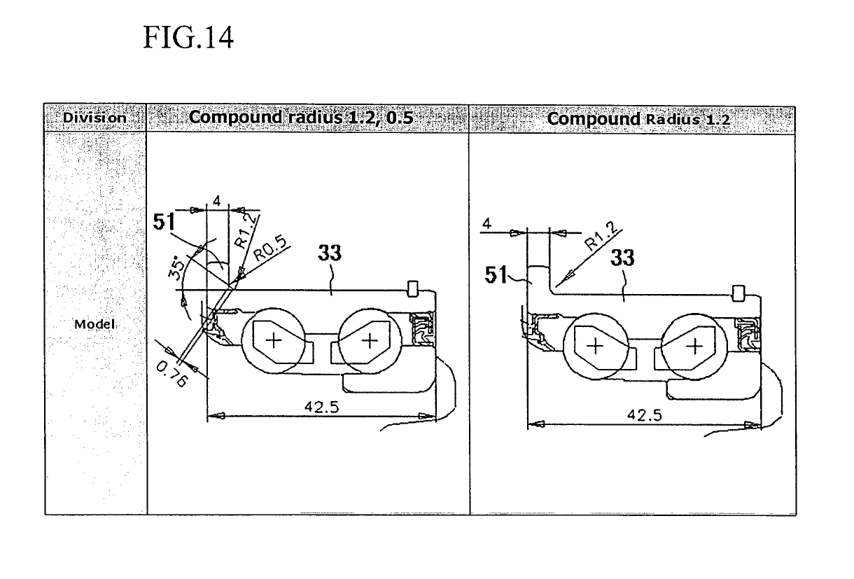

That is, as can be noted from the simulation analysis result shown in FIG. 13, since the maximum stress occurs at the connecting portion P3 between the supporting end 51 and the outer diameter surface 34, the connecting portion P3 between the supporting end 51 and the outer diameter surface 34 of the outer ring 33 is formed in the curved surface to prevent the connecting portion P3 from being cracked. In addition, as shown in FIG. 14, the stress distributions for test samples having supporting ends each having a thickness of 4 mm are analyzed through the simulation analysis under the constant strength test conditions. At this point, the test samples include a “compound radius 1.2, 0.5 test sample” having two curved surfaces formed at both sides of a flat inclined surface of 0.76 mm, one of which has a curvature radius R of 0.5 mm with respect to the supporting end 51 and the other of which has a curvature radius R of 1.2 mm with respect to the outer diameter surface of the outer ring 33 and a “radius 1.2 test sample” having the curved surface having a curvature radius R of 1.2 mm.

According to the simulation analysis results, as shown in FIG. 15, the stress generated at the curved surfaces of the “compound radius 1.2, 0.5 test sample” are 120.34 kgf/mm², and the stress generated at the curved surfaces of the “Radius 1.2 test sample” is 134.20 kgf/mm²F.

The stress values are less than 150.9 kgf/mm² that is the yield strength of the outer ring 33. However, when the curved surface is not provided with the flat inclined surface, the curvature radius R may be 1.2 mm or more. Even when the curved surface is provided with the flat inclined surface, the curvature radius R between the inclined surface and the supporting end 51 may be 0.5 mm or more.

As shown in FIGS. 5 and 6, the ring groove 53 is formed at the inner side of the outer diameter surface 34 of the outer ring 33 and the snap ring 41 is inserted in the ring groove 53. Even when the load increases, the load applied to the snap ring 41 is not big since the load is distributed as a fitted load between the knuckle 20 and the outer ring 33 of the bearing 30. Therefore, the thickness of 0.5 mm or more will be enough for the snap ring 41. Therefore, a width of the ring groove 53 may be 0.5 mm or more.

At this point, a portion between an inner circumference and both inner surfaces of the ring groove 53 may be formed in the curve surface having a curvature radius of 0.1 mm or more to prevent the generation of the crack.

As described above, as the dimensions of the supporting end 51 and ring groove 53 of the outer ring are established as optimal dimensions within the allowable threshold range according to the theory foundation, the optimal structural strength of the outer ring 33 can be attained and thus the theory service life of the bearing can be prolonged.

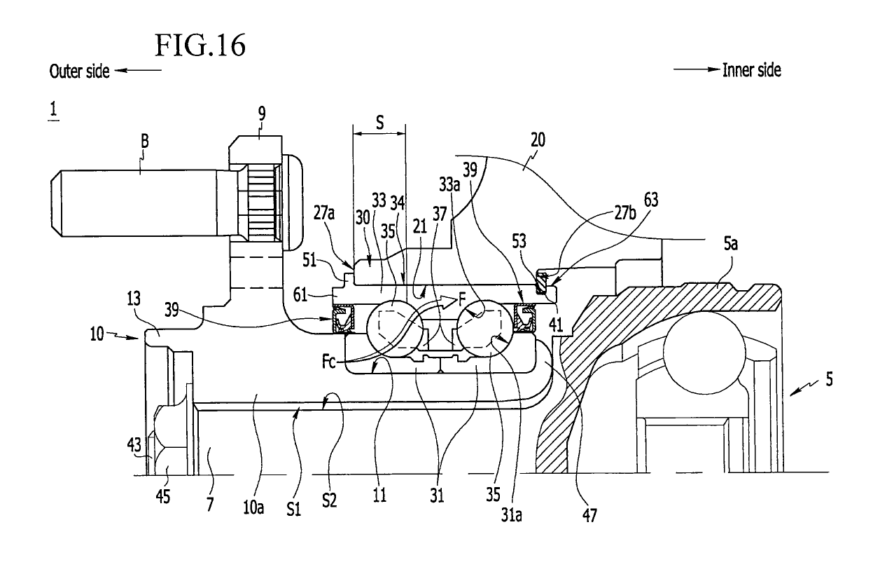

FIG. 16 is a cross-sectional view taken along line A-A of FIG. 1, illustrating a wheel bearing assembly to which an outer ring for a wheel bearing according to a second exemplary embodiment of the present invention is applied.

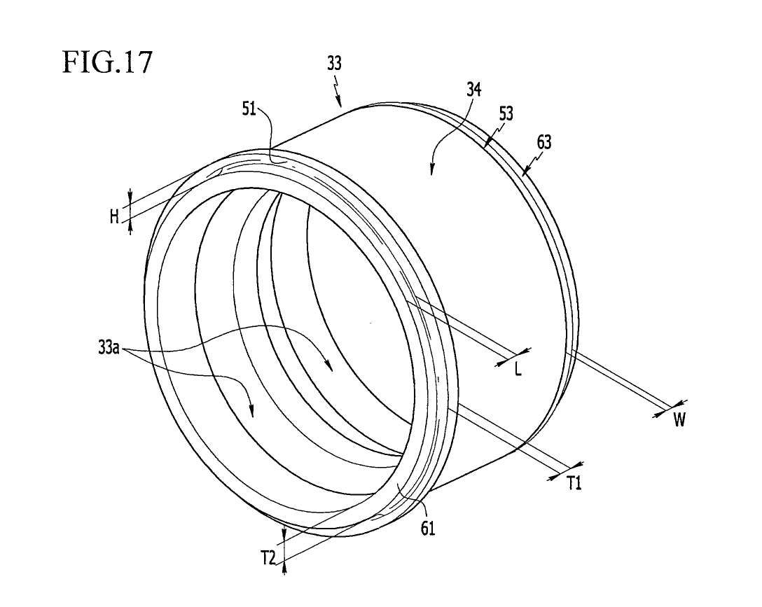

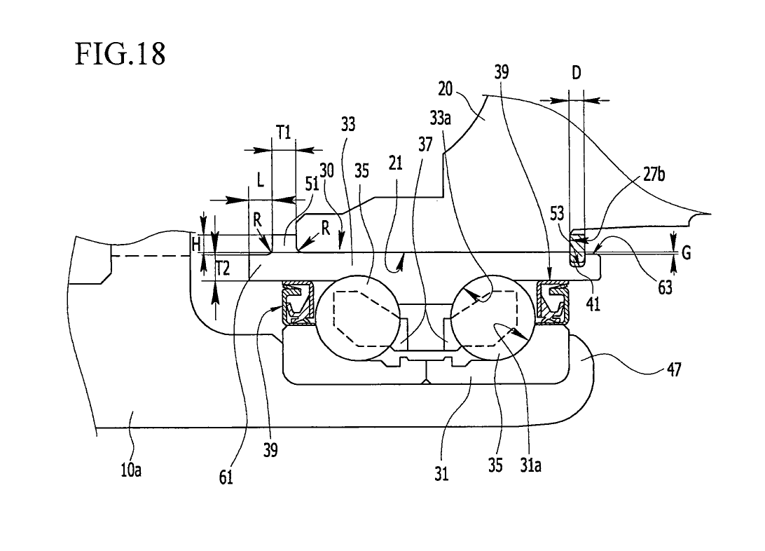

FIGS. 17 and 18 are respectively perspective and partly enlarged sectional views of the outer ring of FIG. 16.

As shown in FIG. 16, a wheel bearing assembly 1 to which an outer ring 33 of a second exemplary embodiment is basically identical to that of the first exemplary embodiment of FIGS. 4-15 except for the followings.

The outer ring of the second exemplary embodiment further includes an extending end 61 formed on an outer side front end surface thereof in addition to the supporting end 51 and the ring groove 53 of the outer ring 33 of the first exemplary embodiment. The extending end 61 allows a seal member installing space for the seal member installed on the bearing 30 to be attained and thus the space usability of the outer ring 33 can be improved.

A thickness T2 of the extending end 61 may be established to be less than a thickness of an outer end portion of the outer ring 33 and a length L of the extending end 61 may be established to be 0.5 mm or more.

In addition, the connecting portion between the extending end 61 and the supporting end 51 may be formed in a curved surface having a curvature radius of 0.1 mm or more to prevent the generation of crack.

In addition, the outer ring 33 is provided with a step surface 63 such that an inner side end portion of the outer ring 33 has a diameter less than an overall diameter of the outer ring 33 in a direction in which the snap ring 41 is installed from the ring groove 53. Therefore, the interference occurring when the bearing 30 is fitted to the inner diameter portion 21 of the knuckle 20 can be reduced and the assembling property of the snap ring 41 can be improved.

At this point, a step G between the outer diameter surface 34 of the outer ring 33 and the step surface 63 may be less than 0.1 mm that is a minimum grinding process margin. If the step G is 0.1 mm or more, the separation force of the snap ring 41 may increase.

According to the outer ring 33 for the bearing of the second exemplary embodiment, the installing space for the seal member 39 can be sufficiently attained by the extending end 61 and thus the space usability of the outer ring 33 can be improved. In addition, the assembling property of the bearing 30 and the knuckle 20 and the assembling property of the snap ring 41 can be enhanced by the step surface 63.

The outer ring for the bearing according to the present invention has the following effects.

As the optimal dimensions within the allowable threshold range are applied to the supporting end that is formed in a flange shape on an outer side end portion of the outer diameter portion of the outer ring and the ring groove in which the snap ring is installed and which is formed on the inner side of the outer diameter portion by establishing theory foundation on the dimension, the outer ring can attain the optimal structural strength and thus the theory service life of the bearing can be prolonged. Furthermore, it can be expected that the weight of the bearing can be reduced within the scope the bearing attains the sufficient structure strength.

Further, since the extending end is formed on the outer side front end surface, the installing space for the seal member can be sufficiently attained and the space usability can be improved. In addition, the lubricant filling space between the inner and outer rings can be enlarged and thus the cooling efficiency can be enhanced.

Since the step surface having a diameter less than an overall diameter of the outer ring is formed on the outer ring from the ring groove to the inner side front end, the assembling property of the snap ring can be improved and the bearing can be assembled on the inner diameter surface of the knuckle without any interference.

While this invention has been described in connection with what is presently considered to be practical exemplary embodiments, it is to be understood that the invention is not limited to the disclosed embodiments. On the contrary, it is intended to cover various modifications and equivalent arrangements included within the spirit and scope of the appended claims.

1. An outer ring for a wheel bearing, comprising:
a supporting end that is formed on an outer side of an outer diameter surface of the outer ring and supported by an outer end of a knuckle; and
a ring groove that is formed on an inner side of the outer ring and supported by an inner end of the knuckle and in which a snap ring is fitted,
wherein the supporting end is dimensioned having a thickness of 1 mm or more at which the supporting end has a stress distribution within yield strength of the outer ring and a height above a section where maximum stress is applied to the supporting end under a cornering load condition less than 3 G.

2. The outer ring of claim 1, wherein, when the thickness of the supporting end is 3 mm or more, the supporting end is dimensioned having a height of 1.65 mm or more.

3. The outer ring of claim 1, wherein a connecting portion between the supporting end and the outer diameter surface of the outer ring is formed in a curved surface.

4. The outer ring of claim 3, wherein the curved surface is formed at two or more portions between the supporting end and the outer diameter surface of the outer ring.

5. The outer ring of claim 3, wherein, when the thickness of the supporting end is 4 mm or more, the curved surfaces are formed at both sides of a flat inclined surface having a predetermined length, including a first curved surface having a curvature radius of 0.5 mm or more with the supporting ends and a second curved surface having a curvature radius of 1.2 mm with the outer diameter surface.

6. The outer ring of claim 3, wherein, when the thickness of the supporting end is 4 mm or more, the curved surface is defined by the supporting end and the outer diameter surface of the outer ring, having a curvature radius of 1.2 mm or more.

7. The outer ring of claim 1, wherein, when a minimum thickness of the snap ring is 0.5 mm, the ring groove is dimensioned having a depth of 0.5 mm or more,

8. The outer ring of claim 1, wherein the ring groove is formed with a curvature radius of 0.1 mm or more between an inner circumference thereof and both inner surfaces.

9. The outer ring of claim 1, wherein the supporting end is dimensioned having a thickness of 3 mm or more at which the supporting end has a stress distribution within yield strength of the outer ring and a height above a section where maximum stress is applied to the supporting end under a cornering load condition less than 3 G.

10. The outer ring of claim 9, wherein the supporting end is dimensioned having a height of 2 mm or more.

11. The outer ring of claim 1, further comprising an extending end extending outward from an outer side front end surface.

12. The outer ring of claim 11, wherein the extending end is dimensioned having a thickness less than a thickness of an outer end portion of the outer ring.

13. The outer ring of claim 11, wherein the extending end is dimensioned having a length in an axial direction of 0.5 mm or more.

14. The outer ring of claim 11, wherein a connecting portion between the extending end and the supporting end is formed in a curved surface having a curvature radius of 0.1 mm or more.

15. The outer ring of claim 1, further comprising a step surface formed from the ring groove and an inner end portion, the step surface having an outer diameter less than an overall outer diameter of the outer ring.

16. The outer surface of claim 15, wherein a step between the outer diameter surface of the outer ring and the step surface is dimensioned having 0.1 mm that is a minimum grinding process margin or less.

17. The outer ring of claim 4, wherein, when the thickness of the supporting end is 4 mm or more, the curved surfaces are formed at both sides of a flat inclined surface having a predetermined length, including a first curved surface having a curvature radius of 0.5 mm or more with the supporting ends and a second curved surface having a curvature radius of 1.2 mm with the outer diameter surface.
